(19) United States
(12) Patent Application Publication
(10) Pub. No.: US 2012/0316924 A1
(43) Pub. Date: Dec. 13, 2012

(54) Dynamic Ticket Pricing

(75) Inventors: Tilmann Bruckhaus, Cupertino, CA (US); Borislav Antonov Ratchev, Sunnyvale, CA (US)

(73) Assignee: EVENTBRITE, INC., San Francisco, CA (US)

(21) Appl. No.: 13/156,063

(22) Filed: Jun. 8, 2011

(51) Int. Cl. G06Q 30/00

(52) U.S. Cl. 705/7.35

(57) ABSTRACT

A dynamic pricing system for online event management and ticket selling systems.

### TECHNICAL FIELD

The present disclosure generally relates to online event management systems and dynamic pricing systems.

### BACKGROUND

Many websites allow users to conduct a variety of actions online, such as viewing content, writing reviews, ordering items, purchasing tickets, etc. These websites often present the user with a plurality of actions to choose from and allow the user to select the type of action he would like to perform. Once the action is selected, the website typically redirects the client system of the user to a webpage where the action can be completed. For example, some websites allow users to organize events using an online event management system. An online event management system may allow an event organizer to organize and manage various aspects of an event, such as, for example, managing attendee registrations and selling tickets, promoting the event, and managing attendee check-in at the event. An online event management system may also allow users to view event listings, register for events, and purchase tickets for events. Online systems, such as online event management systems, can typically be accessed using suitable browser clients (e.g., Firefox, Chrome, Internet Explorer).

Appropriately pricing an event to maximize revenue is a challenge for event organizers. Setting an initial price for an event or a class of tickets to an event and letting it remain static over an entire ticket selling window may result in loss of potential revenue. For example, if an organizer prices an event too low, the event may sell out at the low price where the organizer could have realized additional revenue at a higher ticket price. Furthermore, under-pricing an event may encourage scalpers to purchase the tickets and profit from the event organizer's mis-pricing. Conversely, pricing an event too high may result in a low number of ticket sales. Dynamic pricing for tickets and other types of goods or services have been proposed to address these concerns. Dynamic pricing for event tickets in the online event management space is still developing and permits for much improvement.

### BRIEF DESCRIPTION OF THE DRAWINGS

FIG. 1 illustrates an example system for implementing an online event management system and dynamic pricing system.

FIGS. 2A and 2B are example ticket demand curves.

FIGS. 3A-3E are example ticket selling profiles.

FIG. 4 illustrates an example method for dynamically pricing an event ticket.

FIG. 5 illustrates an example computer system.

FIG. 6 illustrates an example network environment.

### DESCRIPTION OF EXAMPLE EMBODIMENTS

### System Overview

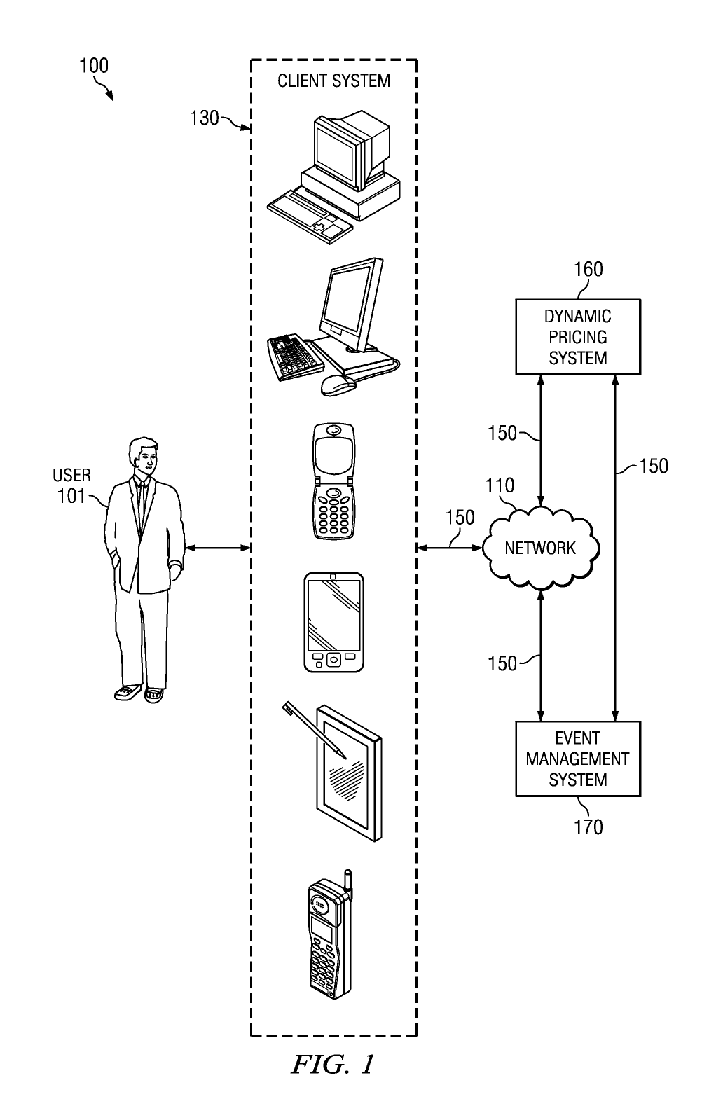

FIG. 1 illustrates an example system 100 for implementing an online event management system and a dynamic pricing system. System 100 includes a user 101, a client system 130, a dynamic pricing system 160, and an event management system 170 connected to each other by a network 110. Although FIG. 1 illustrates a particular arrangement of user 101, client system 130, dynamic pricing system 160, event management system 170, and network 110, this disclosure contemplates any suitable arrangement of user 101, client system 130, dynamic pricing system 160, event management system 170, and network 110. As an example and not by way of limitation, two or more of client system 130, dynamic pricing system 160, and event management system 170 may be connected to each other directly, bypassing network 110. As another example and not by way of limitation, two or more of client system 130, dynamic pricing system 160, and event management system 170 may be physically or logically co-located with each other in whole or in part. As yet another example, one or more dynamic pricing systems 160 may be physically or logically co-located with one or more event management systems 170 in whole or in part. Moreover, although FIG. 1 illustrates a particular number of users 101, client system 130, dynamic pricing systems 160, event management systems 170, and networks 110, this disclosure contemplates any suitable number of users 101, client systems 130, dynamic pricing systems 160, event management systems 170, and networks 110. As an example and not by way of limitation, system 100 may include multiple users 101, client systems 130, dynamic pricing systems 160, event management systems 170, and networks 110.

In particular embodiments, an event management system 170 may be a network-addressable computing system that can host one or more event organization and management systems. An event management system 170 may generate, store, receive, and transmit event-related data, such as, for example, event listings, event details, event history details, event registration details, event organizer details, event attendee details, ticket purchase details, and event displays. An event management system 170 may be accessed by the other components of system 100 either directly or via network 110. In particular embodiments, dynamic pricing system 160 may be a network-addressable computing system that can host one or more dynamic pricing engines or modules. Dynamic pricing system 160 may generate, store, receive, and transmit dynamic pricing-related information, such as, for example, event-related data, event organizer information, and suggested pricing for an event. Dynamic pricing system 160 may be accessed by the other components of system 100 either directly or via network 110. Dynamic pricing system 160 may be an independent system or a subsystem of event management system 170.

In particular embodiments, one or more users 101 may use one or more client systems 130 to access, send data to, and receive data from an event management system 170. A client system 130 may access an event management system 170 directly, via network 110, or via a third-party system. A client system 130 may be any suitable computing device, such as, for example, a personal computer, a laptop, a cellular phone, a smart phone, or a computing tablet. In particular embodiments, one or more users 101 may be an automated system, such as, for example, a computer program, an internet bot, another type of automated system, or two or more such systems.

Network 110 may be any suitable communications network. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Connections 150 may connect client system 130, dynamic pricing system 160, and event management system 170 to communication network 110 or to each other. This disclosure contemplates any suitable connections 150. In particular embodiments, one or more connections 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 150 each include an ad hoc network, an intranet, an extranet, a VPN, a LAN, a WLAN, a WAN, a WWAN, a MAN, a portion of the Internet, a portion of the PSTN, a cellular telephone network, another connection 150, or a combination of two or more such connections 150. Connections 150 need not necessarily be the same throughout system 100. One or more first connections 150 may differ in one or more respects from one or more second connections 150.

### Event Management Systems

In particular embodiments, an event management system 170 may allow users to create, organize and manage events. An event may be, for example, a party, a concert, a conference, a sporting event, a fundraiser, a networking event, or a live performance. Events may occur online (such as, for example, a web-based seminar) and offline (such as, for example, a live seminar in a lecture hall). An online event management system may allow an event organizer to organize and manage various aspects of an event, such as, for example, managing attendee registrations and selling tickets, managing funds from ticket sales, promoting the event, and managing attendee check-in at the event. An online event management system may also allow event attendees to view and manage various aspects of registering for an event, such as, for example, viewing event listings, viewing event information, viewing event history information, registering for events, and purchasing tickets for events. As an example and not by way of limitation, a first user may use event management system 170 to create and organize an event. The first user may input event information associated with the event. This information may be viewable in one or more web pages or other content served by event management system 170. One or more second users may then use event management system 170 to register for the event. The second users may view an event listing associated with the event and then purchase tickets for the event. Although this disclosure describes particular types of events, this disclosure contemplates any suitable types of events. Moreover, although this disclosure describes organizing and managing particular aspects of an event, this disclosure contemplates organizing and managing any suitable aspects of an event.

In particular embodiments, each event that event management system 170 is managing has an associated event listing. An event listing may be accessed and displayed by any suitable client system 130. An event listing may have event information associated with the event listing. Event information may include information describing the event date, type, cost, organizer, promoter, geographic location, venue, performer, attendees, types of classes of tickets available, and other suitable event information. Other information can include hypertext links to resources related to or describing the event, and the like. Although this disclosure describes particular types of event information, this disclosure contemplates any suitable types of event information. An event listing may also have a payment information associated with the event listing. Payment information may include the address verification system code for the payments for the event, the credit cards used to pay for the event, the decline rate for the credit cards, the use ratio of the credit cards, the locations of payers, the IP addresses of the payers, the use ratio of the IP addresses, the number of prior payouts to the event organizer, the amount of prior payouts to the event organizer, and other suitable payment information. Although this disclosure describes particular types of payment information, this disclosure contemplates any suitable types of payment information.

In particular embodiments, each user 101 of event management system 170 may have an event history information associated with the user 101. Event history information may include event information and payment information associated with one or more events a user 101 has attended or has registered to attend, as well as purchase history information associated with the event. Event history information may also include event information and payment information associated with one or more event listings a user 101 has created, organized, and managed. Although this disclosure describes particular event history information, this disclosure contemplates any suitable event history information.

In particular embodiments, the event management system 170 may use unique client identifiers to identify a user 101. As an example and not by way of limitation, the event management system 170 may assign a unique client identifier to each client system 130. The event management system 170 may assign each client system 130 with an unique client identifier based on the IP address of the client system 130, tracking cookies on the client system 130 (which may be appended to HTTP requests transmitted by the client system 130), the serial number or asset tag of the client system 130, or other suitable identifying information. For example, in one implementation, a script implemented in a page downloaded to the client system may access various attributes of the client system 130 to determine a hardware-based signature that can be used to uniquely identify client system 130.

In addition, event management system 170 may maintain an account for each user. An account may be of one or at least two types, such as a consumer (event attendee) account and an event organizer account. A user may be both an attendee of events and an organizer of events. The event management system 170 may assign a unique client identifier to each user 101, which the user must provide to the event management system 170 via a client system 130. The event management system 170 may maintain for each user 101 a username and password that the user 101 can input into client system 130, which then transmits the username and password to the event management system 170. In particular embodiments, the event management system 170 can use the unique client identifier to determine that the user 101 is accessing the system.

In particular embodiments, the event management system 170 may maintain an event management account for a user 101. The event management account may contain a variety of information about the user 101. As an example and not by way of limitation, an event management account may contain personal information (such as, for example, name, sex, location, and interests), social network information (such as, for example, friend connections), financial information (such as, for example, income and credit history), event history information (such as, for example, the type, data, cost, venue, performers, and geographic location of the events a user 101 has organized, registered for, or attended), and other suitable information related to the user 101. The event management account may also contain information related to the event listings created by the user, the orders received for tickets to various events, funds collected by event management system 170 from ticket sales for event listings created by the user 101, and information related to funds paid out to the user 101. Although this disclosure describes event management accounts containing particular types of information about a user 101, this disclosure contemplates event management accounts containing any suitable information about a user 101.

### Dynamic Event Pricing

In particular embodiments, the dynamic pricing system 160 is operative to assess ticket selling activity for an event and compute suggested prices for tickets that are predicted to increase the potential revenues from ticket sales to the event. When an event organizer configures a new event, the event organizer sets an initial price for one or more classes of tickets to the event, and provides the number of available tickets for each class. The number of available tickets may correspond to the physical capacity of the event venue, but may also be arbitrarily set by the event organizer. An event organizer can also configure a start and end date to define a ticket selling window, or it can be automatically inferred from the day the event organizer configures the new event and the date the event is to occur. For ease of reference, the following description illustrates application of dynamic pricing to an event with a single class of tickets. Dynamic pricing can be applied to each class of ticket individually, as well, in the cases where an event has multiple ticket classes.

In one implementation, the dynamic pricing system 160 may operate in two phases: an initial price adjustment phase and a subsequent demand curve phase where a demand curve can be modeled. The demand curve may be a Price Elasticity of Demand curve that models the responsiveness or elasticity of the quantity demanded of a good or service to changes in price. For example, after an initial price is set and an event begins to sell, ticket demand can be assessed at the initial price and adjusted as discussed in more detail below. After an initial price adjustment, there are at least two data points (price-ticket demand pairs) that can be used to compute a demand curve to be used in subsequent suggested price adjustments.

### Initial Price Adjustment

The dynamic pricing system 160 may evaluate the number of tickets in each ticket class sold for the event after a period of time and may compute an initial price adjustment based on observed ticket sales during this initial period of time. The initial period of time may be 24 hours or any other period of time from the start of the ticket selling window. In one implementation, the dynamic pricing system 160 waits for several days after the start of the ticket selling window before computing an initial price adjustment. In other implementations, computation of the initial price adjustment can be performed on demand in responses to a request from a user. In one particular implementation, the dynamic pricing system 160 may estimate the number of tickets that will be sold (ticket demand—a predicted number of tickets that will be sold over the ticket selling window) at the current price based on the number of tickets during the initial period of time since event ticket sales were initiated.

As discussed in more detail below, the ticket demand can be predicted initially by analyzing observed ticket sales during this initial period to predict the overall number of tickets that may be sold at the current price over the purchase window. The first days of purchase activity in a ticket selling window may be indicative of a ticket selling profile of a plurality of ticket selling profiles (as discussed below). Upon selection of a ticket selling profile, the dynamic pricing system 160 can predict the total percentage of available tickets that will be sold—i.e., the ticket demand at the current price. For example, the initial period of time may be 1 to 3 days (as a non-limiting example), ticket selling activity for the event can be assessed at a desired granularity (e.g., every day, every 12 hours, every 4 seconds, etc.) and compared to historical ticket selling profiles in order to predict the ticket demand for the current event.

If the ticket demand is less than the number of available tickets, then dynamic pricing system 160 may suggest a price decrease. If the predicted number of tickets sold is greater than the number of available tickets, then dynamic pricing system 160 may suggest a price increase. The monetary adjustments for increasing/decreasing price can be a fixed increment, a fixed percentage of the original price, a function of the original price, a function of the difference between a computed optimal price and the current price, and the like. Various increments, parameters or weightings can be user configurable as well. In some implementations, a user may set minimum and maximum prices, or rules, such as “never increase price”, and “never decrease price”. A user may also elect to have prices adjusted automatically or after user confirmation. The pricing engine may also indicate a confidence level for a recommended price, such as a statistically derived confidence figure.

The price adjustment may be automatically implemented or manually selected. In one example implementation, an event organizer may configure a new event and check back after a period of time to assess the number of tickets sold. The dynamic pricing system 160 may assess ticket demand at the initial price and compute a suggested price adjustment. The event organizer may choose to use this new price or use it as guidance in adjusting the price for the event. In some implementations, the event organizer may opt to have the dynamic pricing system 160 automatically change the price.

### Modeling of Ticket Demand Curve

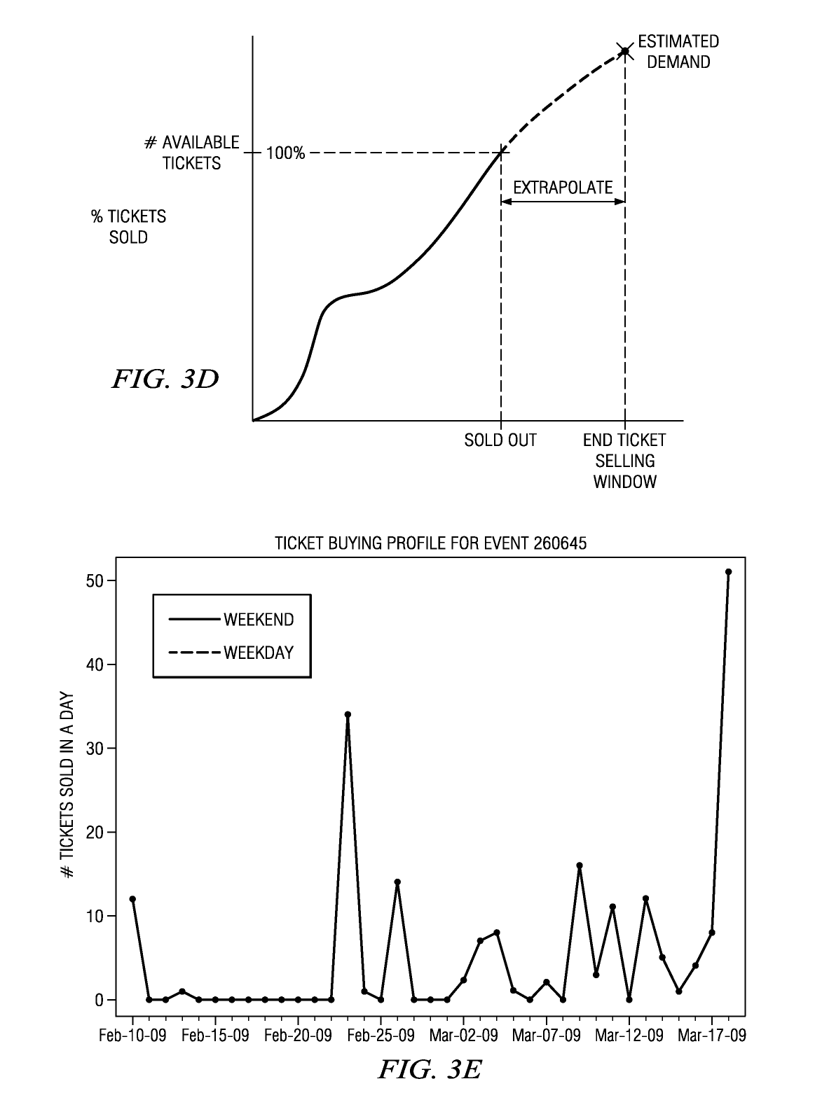

After ticket selling has occurred for an event at two or more different prices, the dynamic pricing system 160 may model a ticket demand curve. FIG. 4 illustrates an example process flow for dynamically adjusting the price of a ticket to an event. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components carrying out particular steps of the method of FIG. 4, this disclosure contemplates any suitable combination of any suitable components carrying out any suitable steps of the method of FIG. 4.

In a particular implementation, the dynamic pricing system 160 estimates ticket demand at the price levels (P1, P2, etc.) that have been set during the ticket selling window for the event (402). Computation of ticket demand (i.e., the predicted total number of tickets sold at the end of a ticket selling window) at a given price level is discussed below.

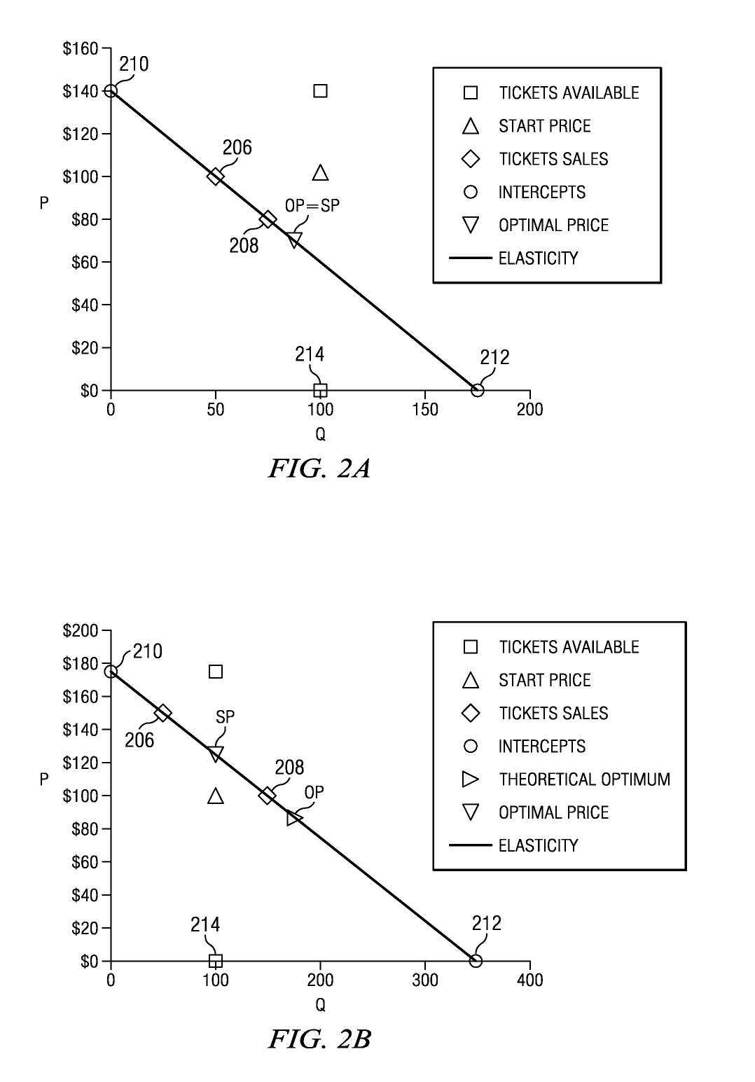

The dynamic pricing system 160 then constructs a ticket demand curve based on the computed demand-price pairs (404). With two price-demand pairs or data points, the dynamic pricing system 160 can create a demand curve by forming a line that intersects the data points on a plot of price versus demand. With additional data points, the dynamic pricing system 160 may use regression analysis and/or curve fitting to compute a demand curve, as well as R-squared, standard deviation, and other derivative values that could be used in weighting or other aspects of a dynamic pricing function. FIGS. 2A and 2B illustrate example demand curves. As FIG. 2A illustrates, for example, a plot of demand (Q) versus price (P) can be computed based on observed ticket sales at two prices (206, 208). Intercepts 210, 212 form the endpoints of the demand curve.

The dynamic pricing system 160, based on the computed demand curve, computes a theoretically optimal price (OP) (406). In one implementation, the optimal price is the price that maximizes the area defined by the price and corresponding ticket demand. In some implementations, the dynamic pricing system 160 sets the optimal price as the mid-point of the demand curve, as illustrated in FIG. 2A.

The dynamic pricing system 160 then compares the predicted ticket demand at the optimal price to the number of available tickets to determine a suggested price (408). FIG. 2A graphically illustrates a low-demand scenario where the ticket demand at the theoretically optimal price is less than the number of available tickets 214. In this scenario, the dynamic pricing system 160 may set the suggested price (SP) to the theoretically optimal price (410). FIG. 2B graphically illustrates a high demand scenario where the ticket demand at the theoretically optimal price is greater than the number of available tickets 214. In this scenario, the dynamic pricing system 160 may set the suggested price (SP) to the price on the demand curve where the ticket demand equals the number of available tickets (412).

A variety of alternative implementations are possible. For example, the dynamic pricing system 160 may perform error and sanity checking functions. For example, noise could create a situation where the slope of the estimated demand curve is positive. The dynamic pricing system 160 could limit the slope of the demand curve to values of zero or below in such situations. Alternatively, the dynamic pricing system 160 could return a notice indicating that there is insufficient data to compute the demand curve. The dynamic pricing system 160 may then rely on additional time at the current price level to refine the estimated ticket demand and/or rely on an additional price adjustment based on the preceding initial price adjustment operations to gather additional data points.

Still further, R-squared values or other indicators of modeling confidence may result in a weighted adjustment of the price from the configured price. For example, the adjusted price may be based on a weighted difference between the suggested price and the price originally configured by the event organizer, where the weighting value is based on the confidence level of the modeled demand curve.

In addition, the dynamically determined price (whether raw or weighted) can be used in a variety of ways. For example, the dynamic pricing system 160 may display the dynamic pricing to an event organizer as a suggested price, requiring the event organizer to approve its implementation (or simply use as guidance when manually adjusting price). In some implementations, the dynamic pricing for the event can be implemented automatically within limits defined by the event organizer. For example, an event organizer may specify a minimum and/or maximum price that will limit the price adjustments made by the system. Still further, the event organizer may have the option to manually override the dynamically computed price at any time. Furthermore, the dynamic pricing system 160 may transmit notifications to the event organizer if a price change occurs or if the price is adjusted above or below certain alarm thresholds configured by the event organizer.

A variety of implementations are possible. Based on the historical ticket selling profile, the system may identify time periods that are candidates for price increase or decrease based on increased or decreased historical quantity sold. If the initial period of ticket sales follows the expected average reference distribution, the system may follow the predetermined price increases/decreases based on the historical distribution. If the initial period deviates from historical data in a significant manner (e.g. >x standard deviations), the dynamic pricing system 160 may change the price in a way that would bring the current profile more in line with the historical data. In addition, the dynamic pricing system 160 may account for events taking place on weekends or holidays—such as providing for higher prices for those time periods.

### Ticket Selling Profiles and Estimating Ticket Demand

As mentioned above, ticket selling profiles may be used to estimate the ticket demand at various price levels for an event. The event management system 170 may store historical data for ticket sales from past events. For example, the event management system may maintain data that stores the total number of tickets sold in respective time bins (e.g., a 4-hour or 24-hour period, etc.) for the duration of a ticket selling window. In one implementation, the raw data may be maintained (such as sales event, time stamp, and amount) and queried.

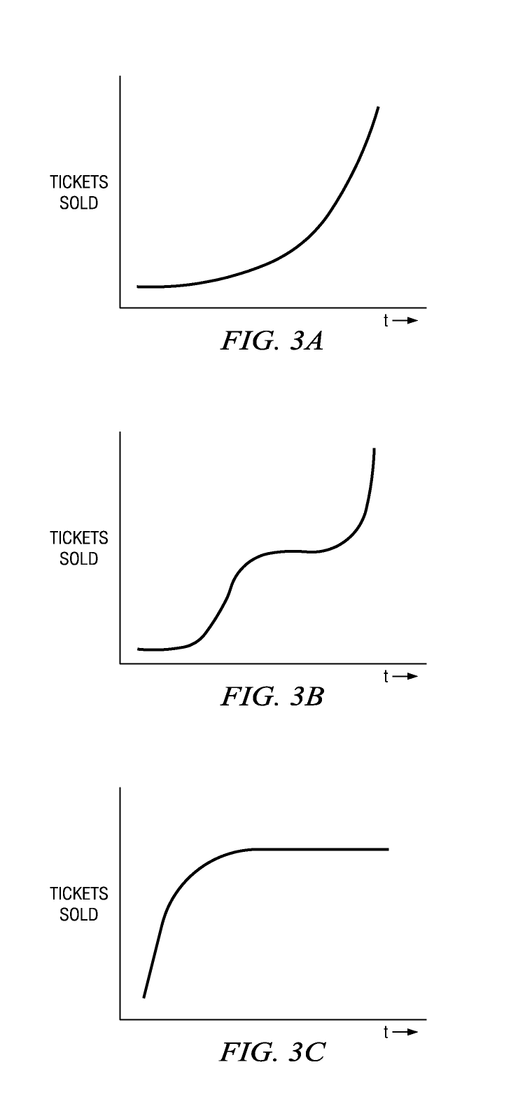

Events have different ticket selling trajectories. Over some ticket selling window defined by a start and end date/time, the event management system 170 sells tickets for an event. The event management system 170 can record the number of tickets sold in a given time interval or bin during the ticket selling window for events to develop historical data that can be used for predictive purposes generally and dynamic pricing in particular. A ticket selling profile can be based on multiple events or a single event. Furthermore, the ticket selling profiles can be graphed cumulatively (where each time bin represents the tickets sold from the start to that time bin) or discretely (where each time bin represents tickets sold in that time bin). FIG. 3E graphically illustrates a ticket selling profile for a single event as a function of time, where each time bin represents tickets sold in that time bin. FIGS. 3A-3C graphically illustrates three different example, aggregate ticket selling profiles that are based on historical data aggregated across several events. The graphs of FIGS. 3A, 3B and 3C show the number of tickets sold for a given event type over the temporal courses of their respective ticket selling windows. For example, FIG. 3A corresponds to an event type where more of the tickets are sold nearer to the end of the ticket selling window, while FIG. 3C corresponds to an event type where more of the tickets are sold at the start of the ticket selling window. The ticket selling profiles can vary considerably between these extremes, as illustrated in FIG. 3B. Those skilled in the art will understand that FIGS. 3A, 3B and 3C are merely a few of a variety of different ticket selling profiles.

Ticket selling windows and the event capacity or number of available tickets typically vary across a variety of events. Accordingly, ticket selling profile data can be normalized. For example, the time axis and corresponding time bins can be expressed as percentages of the event selling window, while the number of tickets sold, and number of tickets demanded, can be expressed as a percentage of the number of available tickets for the event. An example granularity of the time axis of the ticket selling profile may be 1 percent, 5 percent or 10 percent. Alternatively, the ticket selling time axis may be a continuous curve. The granularity used is an engineering design chose that can vary considerably based on a number of objectives and considerations, such as the amount of data to be stored, the frequency with which the dynamic pricing is to be run for a given event and the like. Interpolation may be used if the data point to be modeled falls between any two percentile values of the temporal axis. Furthermore, the granularity of the percentile time bins may vary across the ticket selling window with more data points in the beginning and end, and less granularity and fewer data points in the central portion of the ticket selling window.

Some events may sell out before the end of the ticket selling window. FIG. 3D illustrates an example ticket selling window where the event sold out prior to the end of the ticket selling window. In some implementations, the dynamic pricing system 160 may extrapolate the data from the point the event sold out to the end of the ticket selling window. In such instances, the percentage of tickets sold for the extrapolated values may exceed 100 percent. Any suitable extrapolation method can be used, including (but not limited to) linear extrapolation, polynomial extrapolation, conic extrapolation and French curve extrapolation. The extrapolation may also process cumulative sales per period, in addition to sales per period.

Selection of a ticket selling profile may include one or both of categorizing an event and selecting a ticket selling profile based on the category and fitting observed ticket selling activity for the event to a ticket selling profile. To select a ticket selling profile for a particular event, the dynamic pricing system 160 may examine the current ticket selling data, performing any normalization required, such as converting time intervals to percentages of a ticket selling window and number of tickets sold to percentages of the number of available tickets. The resulting data points can be used to identify a, or a set of, best fitting ticket selling profile(s) from historical data. For example, a ticket selling profile may be represented as a data set of tickets sold during each period of the sales window. The period may be represented as days since start of sales, seconds till end of sales, percent of sales window transpired, or similar. Alternatively, a ticket selling profile may be represented as a data set of cumulative ticket sales since start of sales window. The system may compute ticket selling profiles from groups or categories of historical events to be used as benchmarks for dynamic pricing of a similar event.

For example, the system may match an event under consideration to a category or event group and use a ticket selling profile from the matched category of events. The ticket selling profile for a given category can correspond to a single past event, or be derived from historical data by computing the percent of tickets sold during each time during the sales window for all events in the historical data set. The system may derive the ticket selling profile as the average value across all historical events. That is, the profile contains the average percentage of tickets sold at each time during the selling window across similar events. The system may also use other suitable functions in place of the average, such as the median or 75^{th} percentile. A ticket selling profile may be generated using scaling in quantity sold and interpolation in time in order to make events of different duration comparable to one another. Winsorized Means and Standard Deviations can also be used in order to avoid skewing the mean values via outliers.

To select the selling profile to be used with a particular event, the system may use data sets for similar events, such as “music”, “professional conferences or seminars,” “sports event,” etc. If sales for an event are currently ongoing, the system may alternatively use profiles that mathematically fit the historical selling data of the event if ticket sales are ongoing. Techniques such time series forecasting (e.g., Holt-Winters, Exponential Smoothing, ARIMA, etc.) combined with error metrics, such as Mean Absolute Percent Error (MAPE), Mean Absolute Error (MAE), Least Squares or Minimum Absolute Percentage Error, may be used for fitting. The system may also compare historical selling data of an event with ongoing sales to the corresponding sales data from a reference profile. Techniques such as correlation coefficients may be used for fitting. For this purpose, the system may create candidate profiles from historical events. In a first step, the system clusters events into subsets of similar events, based on each event's selling history. Mathematical modeling techniques, such as k-means or Kohonen clustering can be used for this purpose. For example, the system may cluster events based on ticket sales during each of 100 percentiles of the sales window. In a second step, the system derives a representative selling profile for each subset of similar events. The representative selling profile is derived as described above, by using averages, medians, or similar metrics.

In one implementation, either the selected profile based on category and/or the best fitting curve of the ticket selling profile can be used to predict the quantity sold at the end of the ticket selling window. This value is used as predicted ticket demand at a given price under consideration. As discussed above, the predicted demand can be based on an actually observed value at the end of the ticket selling window or an estimated value based on extrapolation to the end of the ticket selling window for a selected ticket selling profile. The ticket selling profile used in this prediction may change as time within the ticket selling window of the instant event passes (and more data points are available) and the dynamic pricing algorithms described herein are re-run. To compute total ticket demand, the percentage value can be multiplied by the total number of available tickets.

At or near the beginning of a ticket selling window (where there are fewer data points to use to evaluate a best fitting curve), the confidence of fitting an observed ticket selling data set to one of the ticket selling profiles may be low. In some implementations, the dynamic pricing system 160 can defer computation of a suggested price until the confidence match is beyond a threshold level. Alternatively or additionally, the dynamic pricing system 160 may weight the price adjustment (delta between current price and suggested price) based on a confidence level.

A variety of implementations are possible. For example, data from different events that have similar observed ticket selling profiles can be aggregated to create a ticket selling profile that can be used as a model profile for that type of behavior group. The dynamic pricing system 160 can use machine learning to find clusters of similar ticket selling profiles, and then use classification to find the closest match to use in the prediction. The dynamic pricing system 160 may also group or categorize ticket selling profiles by event type, event organizer, target demographics, and/or any other suitable factors or attributes to identify a subset of events whose historical ticket selling profiles are searched.

### Systems and Methods

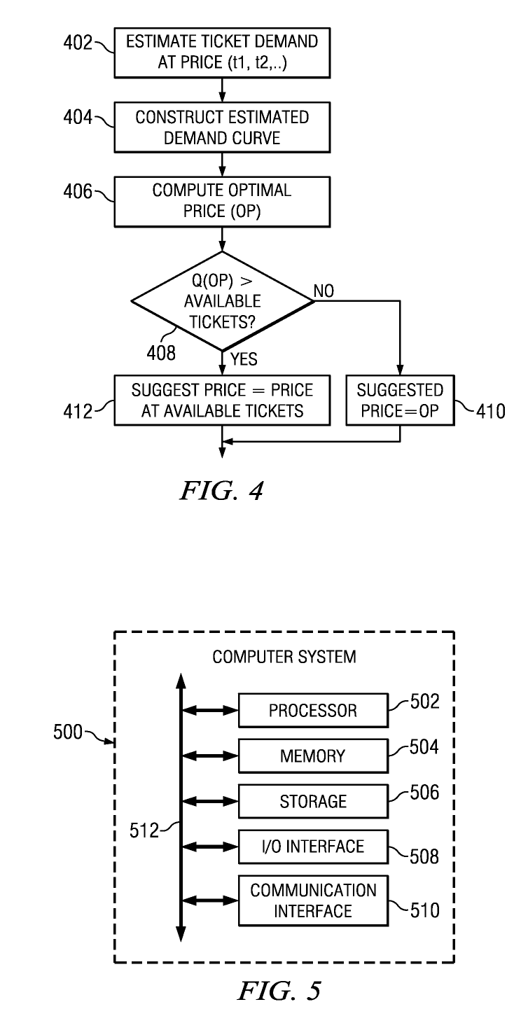

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include an HDD, a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 502 (such as, for example, one or more internal registers or caches), one or more portions of memory 504, one or more portions of storage 506, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

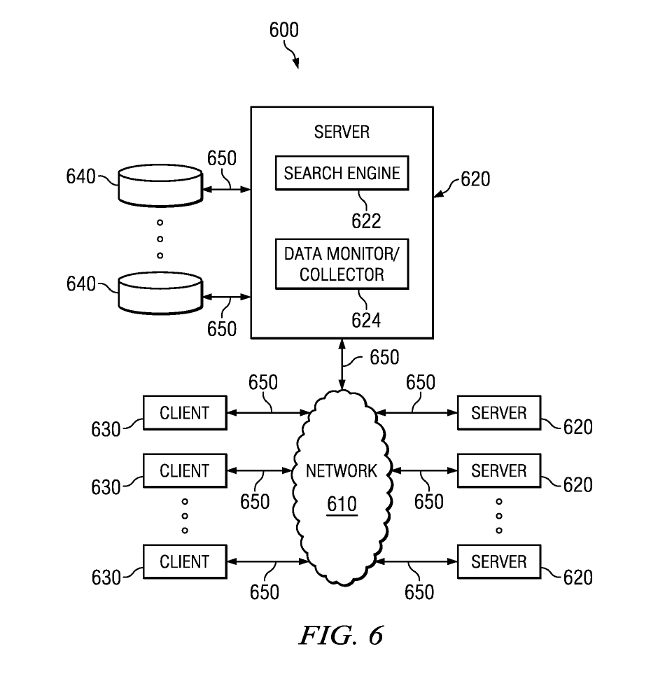

FIG. 6 illustrates an example network environment 600. This disclosure contemplates any suitable network environment 600. As an example and not by way of limitation, although this disclosure describes and illustrates a network environment 600 that implements a client-server model, this disclosure contemplates one or more portions of a network environment 600 being peer-to-peer, where appropriate. Particular embodiments may operate in whole or in part in one or more network environments 600. In particular embodiments, one or more elements of network environment 600 provide functionality described or illustrated herein. Particular embodiments include one or more portions of network environment 600. Network environment 600 includes a network 610 coupling one or more servers 620 and one or more clients 630 to each other. This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 couple servers 620 and clients 630 to network 610 or to each other. This disclosure contemplates any suitable links 650. As an example and not by way of limitation, one or more links 650 each include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) links 650. In particular embodiments, one or more links 650 each includes an intranet, an extranet, a VPN, a LAN, a WLAN, a WAN, a MAN, a communications network, a satellite network, a portion of the Internet, or another link 650 or a combination of two or more such links 650. Links 650 need not necessarily be the same throughout network environment 600. One or more first links 650 may differ in one or more respects from one or more second links 650.

This disclosure contemplates any suitable servers 620. As an example and not by way of limitation, one or more servers 620 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, a server 620 includes hardware, software, or both for providing the functionality of server 620. As an example and not by way of limitation, a server 620 that operates as a web server may be capable of hosting websites containing web pages or elements of web pages and include appropriate hardware, software, or both for doing so. In particular embodiments, a web server may host HTML or other suitable files or dynamically create or constitute files for web pages on request. In response to a Hyper Text Transfer Protocol (HTTP) or other request from a client 630, the web server may communicate one or more such files to client 630. As another example, a server 620 that operates as a mail server may be capable of providing e-mail services to one or more clients 630. As another example, a server 620 that operates as a database server may be capable of providing an interface for interacting with one or more data stores (such as, for example, data stores 640 described below). Where appropriate, a server 620 may include one or more servers 620; be unitary or distributed; span multiple locations; span multiple machines; span multiple datacenters; or reside in a cloud, which may include one or more cloud components in one or more networks.

In particular embodiments, one or more links 650 may couple a server 620 to one or more data stores 640. A data store 640 may store any suitable information, and the contents of a data store 640 may be organized in any suitable manner. As an example and not by way or limitation, the contents of a data store 640 may be stored as a dimensional, flat, hierarchical, network, object-oriented, relational, XML, or other suitable database or a combination or two or more of these. A data store 640 (or a server 620 coupled to it) may include a database-management system or other hardware or software for managing the contents of data store 640. The database-management system may perform read and write operations, delete or erase data, perform data deduplication, query or search the contents of data store 640, or provide other access to data store 640.

In particular embodiments, one or more servers 620 may each include one or more search engines 622. A search engine 622 may include hardware, software, or both for providing the functionality of search engine 622. As an example and not by way of limitation, a search engine 622 may implement one or more search algorithms to identify network resources in response to search queries received at search engine 622, one or more ranking algorithms to rank identified network resources, or one or more summarization algorithms to summarize identified network resources. In particular embodiments, a ranking algorithm implemented by a search engine 622 may use a machine-learned ranking formula, which the ranking algorithm may obtain automatically from a set of training data constructed from pairs of search queries and selected Uniform Resource Locators (URLs), where appropriate.

In particular embodiments, one or more servers 620 may each include one or more data monitors/collectors 624. A data monitor/collection 624 may include hardware, software, or both for providing the functionality of data collector/collector 624. As an example and not by way of limitation, a data monitor/collector 624 at a server 620 may monitor and collect network-traffic data at server 620 and store the network-traffic data in one or more data stores 640. In particular embodiments, server 620 or another device may extract pairs of search queries and selected URLs from the network-traffic data, where appropriate.

This disclosure contemplates any suitable clients 630. A client 630 may enable a user at client 630 to access or otherwise communicate with network 610, servers 620, or other clients 630. As an example and not by way of limitation, a client 630 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. A client 630 may be an electronic device including hardware, software, or both for providing the functionality of client 630. As an example and not by way of limitation, a client 630 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, or a combination of two or more of these. Where appropriate, a client 630 may include one or more clients 630; be unitary or distributed; span multiple locations; span multiple machines; span multiple datacenters; or reside in a cloud, which may include one or more cloud components in one or more networks.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Furthermore, “a”, “an,” or “the” is intended to mean “one or more,” unless expressly indicated otherwise or indicated otherwise by context. Therefore, herein, “an A” or “the A” means “one or more A,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, this disclosure encompasses any suitable combination of one or more features from any example embodiment with one or more features of any other example embodiment herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more computing devices:
accessing ticket sales data for a first event, wherein the ticket sales data corresponds to a number of tickets sold at one or more time points in a ticket selling window;
selecting for the first event a ticket selling profile from a plurality of ticket selling profiles;
estimating ticket demand at one or more ticket prices for the first event based on the selected ticket selling profile;
constructing a demand curve based on the estimated ticket demand; and
computing an optimal price based on the estimated demand curve.

2. The method of claim 1 wherein selection of the ticket selling profile is based at least in part on a comparison of the ticket sales data for the first event and ticket sales data associated with each of the plurality of ticket selling profiles.

3. The method of claim 1 wherein selection of the ticket selling profile is based at least in part on matching the first event to an event category and selecting a ticket selling profile associated with the event category.

4. The method of claim 1 wherein at least one of the ticket selling profiles is based on an aggregation of historical ticket selling data for a plurality of events.

5. The method of claim 1 wherein at least one of the ticket selling profiles is based on historical ticket selling data for a single past event.

6. The method of claim 1 further comprising adjusting a ticket price for the first event based on the optimal price.

7. The method of claim 6 wherein adjusting the ticket price comprises applying one or more rules to limit the amount by which the ticket price is adjusted.

8. An apparatus comprising: one or more processors; and a memory coupled to the processors comprising instructions executable by the processors, the processors operable when executing the instructions to:
access ticket sales data for a first event, wherein the ticket sales data corresponds to a number of tickets sold at one or more time points in a ticket selling window;
select for the first event a ticket selling profile from a plurality of ticket selling profiles;
estimate ticket demand at one or more ticket prices for the first event based on the selected ticket selling profile;
construct a demand curve based on the estimated ticket demand; and
compute an optimal price based on the estimated demand curve.

9. The apparatus of claim 8 wherein selection of the ticket selling profile is based at least in part on a comparison of the ticket sales data for the first event and ticket sales data associated with each of the plurality of ticket selling profiles.

10. The apparatus of claim 8 wherein selection of the ticket selling profile is based at least in part on matching the first event to an event category and selecting a ticket selling profile associated with the event category.

11. The apparatus of claim 8 wherein each of the ticket selling profiles are based on an aggregation of historical ticket selling data for a plurality of events.

12. The apparatus of claim 8 wherein the instructions are further operative, when executed, to cause the processors to: adjust a ticket price for the first event based on the optimal price.

13. The apparatus of claim 12 wherein adjusting the ticket price comprises applying one or more rules to limit the amount by which the ticket price is adjusted.

14. A method comprising, by one or more computing devices:
accessing ticket sales data for a first event, wherein the ticket sales data corresponds to a number of tickets sold at one or more time points in a ticket selling window at a first ticket price;
selecting for the first event a ticket selling profile from a plurality of ticket selling profiles;
estimating ticket demand at the first ticket price for the first event based on the selected ticket selling profile; and
computing a second, adjusted ticket price based on the first ticket price and the estimated ticket demand.

15. The method of claim 14 wherein computing the second, adjusted ticket price is further based on a comparison between the estimated ticket demand and a number of available tickets for the first event.
